(19) United States
(12) Patent Application Publication
(10) Pub. No.: US 2001/0001775 A1
(43) Pub. Date: May 24, 2001

(54) Rotational speed converter

(75) Inventor: Mauno Montonen, Outokumpu (FI)

Correspondence Address: Intellectual Property Group, Pillsbury Madison & Sutro LLP, Ninth Floor, East Tower, 1100 New York Avenue, N.W., Washington, DC, 20005-3918, US

(73) Assignee: DIAMONT MACHINE OY

(21) Appl. No.: 09/750,686

(22) Filed: Jan. 2, 2001

Related U.S. Application Data
(63) Continuation of application No. 08/967,735, filed on Nov. 12, 1997.

(30) Foreign Application Priority Data
May 12, 1995 (FI) 952310

(51) Int. Cl. F16H 47/08

(52) U.S. Cl. 475/31; 475/91; 475/104; 475/106

(57) ABSTRACT

The invention is related to a rotational speed converter comprising shafts (1, 2) with bevelled gears fixed thereon, separate bevelled gears (3, 4) which cooperate with said gears fixed onto said shafts and are mounted on a separate shaft (5), a planetary gear (6) connected to said separate shaft, and at least one braking gear (7) acting on said planetary gear. In speed converter ccording to the invention are fluid flow channels (9, 10) connected to the braking gear (7), whereby the fluid volume surrounding said channels is filled with a hydraulic fluid that is arranged to pass through the gaps formed between teeth of the braking gear (7) and the planetary gear (6) from the suction side to the pressure side, and that the converter additionally incorporates a control valve for adjusting the fluid flow from the pressure side (9) to the suction side (10), whereby the hydraulic system thus formed makes it possible to control the fluid pressure on the pressure side thus permitting braking of the braking gear and the rotational speed of the planetary gear in a desired ratio, whereby a stepless conversion ratio from zero to 1:1 between the speeds of the input shaft (1) and output shaft (2) is attained.

The present invention is related to a rotational speed converter comprising shafts with bevelled gears fixed thereon, separate bevelled gears which cooperate with said gears fixed onto said shafts and are mounted on a separate shaft, a planetary gear connected to said separate shaft, and at least one braking gear acting on said planetary gear.

Conventionally, one of the greatest problems in rotational speed conversion and transmission techniques is to provide as stepless and smooth variable-speed conversion as possible. Normally, rotational speed conversion from one shaft to another takes place using a gear box. A conventional gear box comprises a set of predetermined gears wheels and combinations thereof. Such arrangements do not offer a really stepless variable-speed conversion, no matter how small steps are used. Another conventional method of rotational speed conversion is to transmit power between the input and output shafts by means of different chain sprockets and belt pulleys and combinations thereof. However, also such arrangements operate in given steps based on entirely mechanical couplings.

Such prior-art rotational speed converters have in common that the smaller steps of speed conversion are desired, the greater number of elements are required and the higher will be the cost of the system. While electric conversion techniques offer stepless and smooth approaches to speed conversion, the number of applications is limited to certain types of drives only. Moreover, contemporary electric conversion systems are hampered by their large size and complicated construction involving a great number of elements and components.

It is an object of the present invention to provide a rotational speed converter capable of overcoming the draw-backs of conventional speed conversion equipment. It is a particular object of the invention to provide a rotational speed converter offering a stepless method of rotational speed conversion. It is still a further object of the invention to provide a rotational speed converter featuring a simple and compact construction as compared with conventional equipment combined with a low manufacturing cost.

The goal of the invention is achieved by virtue of a rotational speed converter characterized in the annexed claims.

In the rotational speed converter according to the invention, to the braking gear are connected fluid flow channels, whereby the fluid volume surrounding said channels is filled with a hydraulic fluid that is arranged to pass through the gaps formed between teeth of the braking gear and the planetary gear from the suction side to the pressure side. Additionally, the converter incorporates a control valve for adjusting the fluid flow from the pressure side to the suction side, whereby the hydraulic system thus formed makes it possible to control the fluid flow rate to vary the fluid pressure on the pressure side thus permitting braking of the braking gear and the rotational speed of the planetary gear in a desired ratio, whereby a stepless conversion ratio from zero to 1:1 between the input and output shaft speeds is attained. The greatest benefits thus obtained over conventional techniques are a simple construction, high reliability in service and small number of components required. An additionally important advantage is the small size of the converter as compared to its large conversion range. Varied applications of the invention can be found in almost all sectors of technology.

In a preferred embodiment of the invention, the case of the converter forms the space holding the hydraulic fluid circulating between the planetary gear and the braking gear. Such a construction is easy to manufacture and maintain.

In the following, the construction and specific operating principle of the invention will be examined in more detail with reference to the attached drawing in which

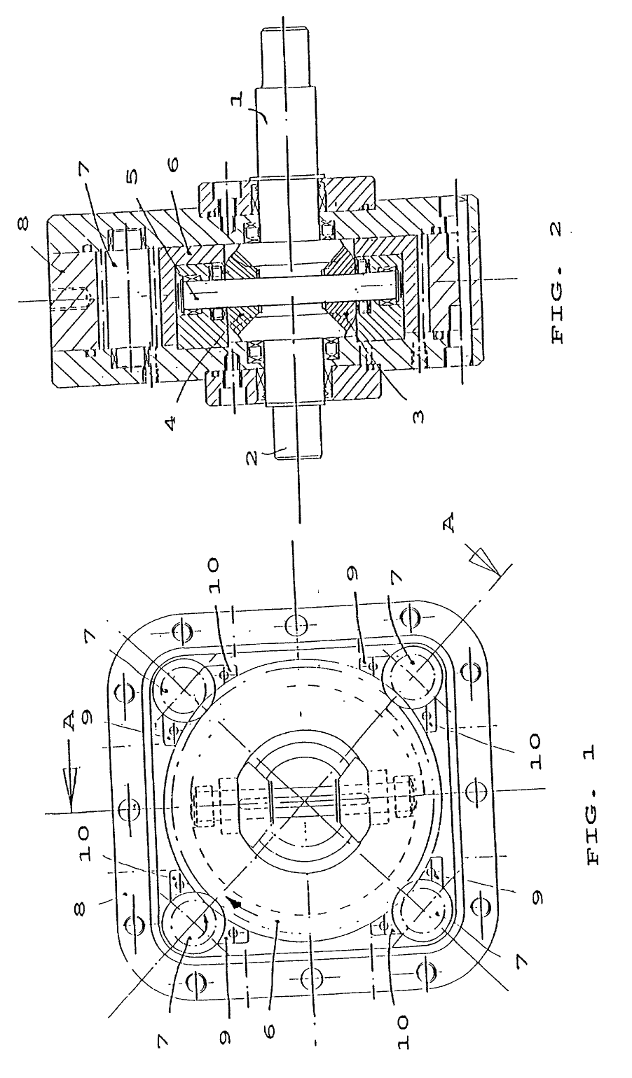

FIG. 1 is a top view of a converter according to the invention with the top cover removed; and

FIG. 2 is a sectional view along the plane A-A marked in FIG. 1 illustrating the elements related to the function of the converter.

Referring to the FIGS. 1 and 2, the embodiment of a rotational speed converter shown therein comprises a case 8 having a first shaft 1 and a second shaft 2 partially enclosed by the case, with bevelled gears mounted to the inner ends of said shafts in a fixed manner, separate bevelled gears 3, 4 placed in the spade between said shafts with a separate shaft 5 attached to said separate gears, a planetary gear 6 connected to said separate shaft, and braking gears 7. While the number of the braking gears may be varied according to the application, the embodiment shown herein uses four separate braking gears placed symmetrically about the planetary gear. To the braking gears are connected fluid flow channels 9, 10 having the space surrounding them filled with a hydraulic fluid. Any type of suitable fluid can be used herein such as hydraulic oil.

When the braking gears are kept stalled, the separate bevelled gears 3, 4 are arranged to transmit the input speed of the first shaft 1 directly in ratio 1:1 to the second shaft 2. Hence, by applying torque to the input shaft 1 to rotate the shaft, the locking of the braking gears 7 causes the torque to be transmitted via the bevelled gears 3 and 4 directly to the output shaft 2. Here, the transmission ratio is exactly 1:1.

In the case that the output shaft 2 is kept stalled by an external load and the braking gears 7 are unlocked, the planetary gear 6 is forced to rotate with the rotation of the input shaft 1. This motion is caused by the fact that the bevelled gears 3 and 4 are connected via the separate shaft 5 to the planetary gear 6. Because the output shaft 2 is stalled, the planetary gear 6 is forced to rotate. Here, the rotational speed of the output shaft 2 is zero.

With the planetary gear 6 arranged to rotate clockwise as marked by an arrow in FIG. 2, the fluid flow channels are divided into a suction-side channel 10 and a pressure-side channel 9. The planetary gear 6 and the braking gears 7 act as a gear pump transferring hydraulic oil in their tooth gaps from the suction-side channel 10 to the pressure-side channel 9. The case 8 acts as both a support of the gears and a hydraulic oil space. The end clearances of the gears are appropriately designed to permit the rotation of the gears while simultaneously preventing the hydraulic oil from escaping via the clearances and the plays against the case from the spaces of the pressure side 9 to the suction side 10.

Braking is accomplished by means of a conventional hydraulic control valve (not shown), which is mounted external to the case of the converter and serves to adjust in a conventional manner the flow of the hydraulic oil from the pressure-side spaces 9 to the suction-side spaces 10. As soon as the oil space provided by the pressure-side spaces 9 becomes filled with the hydraulic oil and the flow of the oil to the suction-side spaces 10 is cut off, the motion of the braking gears 7 and the planetary gear 6 is stalled, because the available oil space is filled with incompressible hydraulic oil. At this stage, the external load stalling the output shaft 2 can be reduced, whereby the rotational speed of the shaft 2 starts to increase steplessly. Thus, the rotational speed of the input shaft 1 is transmitted to the output shaft 2 in a desired reduction varying from zero to 1:1.

Accordingly, the invention is applicable for use as a rotational speed converter in, e.g., lift machinery, where it also finds use as a brake.

As the function of the rotational speed converter may be inverted, it can also be used as a brake permitting “soft-stopping” of a rotational motion. Moreover, the converter may additionally provide a free-wheeling mode in a situation not requiring power transmission through the converter. Further applications can be found in vehicle technology and in combination with electric motors and other power sources.

Not limited by the preferred embodiment described above, the invention may be varied within the scope and spirit of the annexed claims.

1. A rotational speed converter comprising shafts (1, 2) with bevelled gears fixed thereon, separate bevelled gears (3, 4) which cooperate with said gears fixed onto said shafts and are mounted on a separate shaft (5), a planetary gear (6) connected to said separate shaft, and at least one braking gear (7) acting on said planetary gear, characterized in that to the braking gear (7) are connected fluid flow channels (9, 10), whereby the fluid volume surrounding said channels is filled with a hydraulic fluid that is arranged to pass through the gaps formed between teeth of the braking gear (7) and the planetary gear (6) from the suction side to the pressure side, and that the converter additionally incorporates a control valve for adjusting the fluid flow from the pressure side (9) to the suction side (10), whereby the hydraulic system thus formed makes it possible to control the fluid pressure on the pressure side thus permitting braking of the braking gear and the rotational speed of the planetary gear in a desired ratio, whereby a stepless conversion ratio from zero to 1:1 between the speeds of the input shaft (1) and output shaft (2) is attained.

2. A rotational speed converter as defined in claim 1, said converter incorporating a case (8) for said elements, characterized in that said case (8) forms the space holding the hydraulic fluid circulating between the planetary gear and the braking gear.

3. A rotational speed converter as defined in claim 1 or 2, characterized in that said separate bevelled gears (3, 4) are located between said shafts (1, 2) and are arranged to transmit the input speed of the first shaft (1) directly in ratio 1:1 to the second shaft (2) when the braking gear is kept stalled.
